(19) United States
(12) Patent Application Publication
(10) Pub. No.: US 2023/0320349 A1
(43) Pub. Date: Oct. 12, 2023

(54) METHOD FOR IMPROVING THE PERFORMANCES OF SYSTEMIC ACTIVE SUBSTANCES AND MICROBIAL INOCULANTS

(71) Applicant: LAMBERTI SPA, Albizzate (IT)

(72) Inventor: Robert OSBURN, Highwood, IL (US)

(73) Assignee: LAMBERTI SPA, Albizzate (IT)

(21) Appl. No.: 18/043,435

(22) PCT Filed: Aug. 26, 2021
(86) PCT No.: PCT/EP2021/073613

§ 371 Date: Feb. 28, 2023

(30) Foreign Application Priority Data
Sep. 8, 2020 (IT) 102020000021232

(51) Int. Cl. A01N 25/22; A01N 25/04; A01N 25/30

(52) U.S. Cl. CPC A01N 25/22; A01N 25/04; A01N 25/30

(57) ABSTRACT

Method for improving the performances of systemic active substances and microbial inoculants comprising the step of applying onto the soil a liquid aqueous formulation comprising a systemic active substance or a microbial inoculant and a depolymerized carboxymethyl cellulose having a weight average molecular weight comprised between 10,000 and 80,000 dalton.

### FIELD OF THE INVENTION

The present invention provides a method for improving the performances of systemic active substances and microbial inoculants comprising the step of applying onto the soil a liquid aqueous formulation comprising a systemic active substance or a microbial inoculant and a depolymerized carboxymethyl cellulose.

### PRIOR ART

Systemic active substances can be described as chemical agents that are absorbed by plant tissue and distributed throughout the plant by its vascular system, and thereby may result, for example, in increasing the resistance of the plants to attack by pests, either by increasing the toxicity or the repellency of the plant to such pests. Systemic active substances are widely used to regulate plant growth and to protect lawns, shrubs, foliage plants, and trees from diseases and from chewing and sucking pests such as aphids, whiteflies, mealybugs and soft scales.

Microbial inoculants, also known as bioinoculants, are agricultural amendments that use beneficial microbes (bacteria and fungi) to promote plant health. Some microbes form symbiotic relationships with certain host plants, like legumes, which are mutually beneficial (biofertilizers). In return for the plant feeding it carbon from photosynthesis the microbes can “fix” atmospheric nitrogen into a form that the plant can use or provide phosphorus. Other microbes do not form a symbiotic relationship with plants, but, when added to soil, can promote plant growth, suppress plant pathogens (biopesticides) or both.

The application of systemic active substances and microbial inoculants to plants is well-known to those skilled in the art.

Systemic active substances may be used in the well-known manners for application, for example by dusting, by spray application to foliage and by drilling a transverse hole in the trunk of the tree into the sap wood and injecting a liquid formulation of the systemic active substance into the hole.

An extensively used method of application comprises applying, the systemic active substance and microbial inoculants onto the soil as an aqueous formulation in such a manner that it can be absorbed along with other soil components by the feeder roots. With small plants, the systemic active substance and microbial inoculant can be applied by drenching or dripping. With larger trees, they can be applied by driving holes in the soil near the feeder roots and filling said holes with the active formulations.

The application of aqueous formulations onto the soil for absorption by the feeder roots will frequently make possible the supply of a sufficient concentration of systemic active substances and microbial inoculants to give the desired effect, for example pest control. However, this method of application is inefficient because of non-uniform or insufficient soil moisture causing reduced or inconsistent performance or leaching out of the soil and migration before the plant can absorb the active substance or reduced survival for the microorganism before the plant can interact with them. This results in loss of efficiency and can cause damage to other crops and contamination of fresh water.

It is therefore highly desirable to develop methods, which would improve moisture uniformity and retention and prevent or reduce leaching and migration of systemic active substances and microbial inoculants, while still maintaining available their biological activity for the plant.

We have now discovered that the addition of a depolymerized carboxymethyl cellulose (depolymerized CMC) to ready-to-use aqueous formulations of systemic active substances and microbial inoculants to be applied onto the soil enhances the movement and retention of the systemic active substances in the soil and allows the microorganism to reproduce and establish populations around the plant roots obtaining sharply improved performances. Moreover, it improves moisture uniformity and retention and prevents or reduces the leaching out of the soil and migration of systemic pesticides and reduce the stress of the microbial inoculants due to fluctuating soil water conditions.

The depolymerized CMC extends the persistence of the systemic active substances and the microbial inoculants in the soil, providing the necessary long periods of availability for absorption or interaction. This reduces the number of applications and decrease costs and ecological damages, such as freshwater contamination. In addition, crop yields and quality can be significantly enhanced.

The depolymerized carboxymethyl cellulose can be provided as stable and pourable aqueous concentrates containing high amounts of the polysaccharide, which can be easily diluted at the application or mixing site to prepare the ready-to-use formulations.

Carboxymethyl cellulose (CMC) has been widely used in the agricultural sector, in particular as thickener or moisturizing agent. In fact, CMC is able to absorb and hold water, when irrigation water is applied, and release it during irrigation intervals or dry periods as needed by the plant.

WO 2007/146055 describes a gelatinous substrate, which releases impregnated water, comprising a mixture of a salt of carboxymethyl cellulose compound, having an average molecular weight ranging between 90,000 and 700,000, a hydrated metallic salt, water and other agrochemical additives.

U.S. Pat. No. 4,865,640 claims a jelly-like substrate, which gradually releases impregnated water, essentially comprising a mixture of: a) CMC ranging from 1-3% by weight having an average molecular weight ranging between 90,000 and 700,000; b) a hydrated metallic salt ranging from 0.1-0.3% by weight; and c) water ranging from 97-99% by weight.

Depolymerized CMC has been used as ingredient of a moisturizing agent for soils in EP 3 122 784 that describes concentrated compositions comprising a depolymerized carboxymethyl cellulose, a compatibilizer and at least one surfactant. These moisturizing agents reduce the losses of moisture from direct evaporation or from channeling and run-through and improve the proportion of soil moisture accessible to plants.

US 2013/061520 relates to a method for reducing the seed loss due to pod-shattering using a composition comprising a low viscosity carboxymethyl cellulose and to the use of a low viscosity carboxymethyl cellulose as pod sealant.

However, as far as the Applicant knows, no one has described the use of depolymerized carboxymethyl cellulose for enhancing the movement and retention of systemic active substances and microbial inoculants in the soil for improved performance and for preventing or reducing the leaching out of the soil and migration of systemic pesticide.

### DESCRIPTION OF THE INVENTION

It is therefore an object of the present invention a method for improving the performances of systemic active substances and microbial inoculants comprising the steps of:
i) preparing a liquid aqueous ready-to-use formulation comprising an effective amount of a systemic active substance or a microbial inoculant and a depolymerized carboxymethyl cellulose (depolymerized CMC) having a weight average molecular weight comprised between 10,000 and 80,000 dalton (Da), and
ii) applying an amount of the aqueous ready-to-use formulation onto soil around the plant such as to have an application rate of said depolymerized CMC of from 0.01 to 3.0 kg/ha, preferably from 0.05 to 1.5 kg/ha.

### DETAILED DESCRIPTION OF THE INVENTION

In the present Application, the expression “depolymerized CMC” defines a carboxymethyl cellulose whose weight average molecular weight has been reduced between 10,000 and 80,000 dalton through a chemical, enzymatic or physical treatment or a combination of these treatments.

The weight average molecular weight of CMC is determined by aqueous gel permeation chromatography (GPC) calibrated with pullulane standards.

In the present Application, the amount of depolymerized CMC in the various embodiments and Examples of the invention indicates the amount of active matter, i.e. the depolymerized polysaccharide, which is determined by aqueous GPC using a purified CMC as standard.

According to a preferred embodiment of the invention, the depolymerized CMC has a weight average molecular weight comprised between 15,000 and 55,000 Da, more preferably from 20,000 to 45,000 Da.

Advantageously, the depolymerized CMC has a degree of substitution (DS) ranging from 0.4 to 1.6, more preferably from 0.6 to 1.2. The expression “degree of substitution” (DS) means the average number of carboxymethyl groups for each anhydroglucose unit of the cellulose.

The Brookfield viscosity of the depolymerized CMC measured at 20 rpm and 20° C. in water solution at 25 wt % concentration is usually below 6500 mPa·s, preferably below 4000 mPa·s, and above 100 mPa·s, preferably above 400 mPa·s.

Usually, the depolymerized CMC of the invention is salified with alkali metal ions, such as sodium or potassium, or ammonium or quaternary ammonium ions. Preferably, the depolymerized carboxymethyl cellulose of the invention is salified with potassium or sodium ions, more preferably with potassium ions.

Many methods useful for the depolymerization of carboxymethyl cellulose are known; we cite, by way of example, those reported in:
EP 382 577, which describes enzymatic hydrolysed from cellulose derivative;
GB 2,281,073, wherein the procedure for obtaining solutions of low viscosity carboxymethyl cellulose from the dissolution of solid mixtures of carboxymethyl cellulose and enzymes is disclosed;
EP 465 992, wherein a procedure for the depolymerization of cellulose ethers with hydrogen peroxide in water is described;
EP 708113, which relates to the obtainment of low molecular weight cellulose ethers by irradiation;
WO 2005/012540 and EP 3 122 784, which disclose a procedure for the enzymatic depolymerization of medium viscosity carboxymethyl cellulose in the form of dispersed powder in a hydro-alcoholic heterogeneous medium.

Practically all these methods are utilizable for the preparation of a depolymerized CMC suitable for the use in the method of the invention. Depolymerized CMC obtained from an enzymatic depolymerization process are the preferred choice.

The depolymerization methods can be applied both on purified and technical grade carboxymethyl cellulose.

Advantageously, the depolymerized CMC is obtained from a technical grade carboxymethyl cellulose having a content of active matter of from 55 to 75 wt % as dry matter. Technical grade CMC are not washed after the etherification reaction and usually contain from 25 to 45 wt % as dry matter of the carboxymethylation by-products. These by-products are mainly, depending on the salification of the CMC, salts of chloride and glycolate, such as sodium chloride and sodium glycolate.

Any type of systemic active substance commonly used in the field are suitable for the realization of the present method.

Examples of suitable systemic active substances are systemic growth regulators or systemic pesticides that are used to protect plants from pests and include, for example, systemic insecticides, fungicides, bactericides, and nematicides.

Preferred systemic insecticides include neonicotinoid-based compounds, GABA antagonists, macrocyclic lactones, carbamates and organophosphates. Examples of neonicotinoid-based compounds include clothianidin, acetamiprid, dinotefuran, imidacloprid, thiamethoxam, nithiazine, nitenpyram, acetamiprid, and thiacloprid. Imidacloprid is particularly preferred. GABA antagonists include acetoprole, endosulfan, ethiprole, fipronil and vaniliprole. Macrocyclic lactones include abamectin, doramectin, emamectin, eprinomectin, ivermectin, milbemectin, lepimectin, moxidectin, selamectin, spinetoram, and spinusad. Carbamates include ethiofencarb, bendiocarb, pirimicarb, carbosulfan, benfuracarb, methomyl, oxamyl, aldicarb, thiodicarb, alanycarb, carbofuran, methiocarb, fenothiocarb, formetanate, xylylmethylcarbarnate, propoxur, isoprocarb and furathiocarb. Organophosphates include disulfoton, phorate, dimethoate, ciodrin, dichlorvos, dioxathion, ruelene, carbophenothion, supona, TEPP, EPN, HETP, parathion, malathion, ronnel, coumaphos, diazinon, trichlorfon, paraoxon, potasan, dimefox, mipafox, schradan, sevin, chlorpyrifos, acephate and dimeton.

Examples of systemic fungicides and bactericides are acylalanines, benzimidazoles, benzothiazoles, oxanthins, organophosphates, pyrimidines, triazoles and antibiotic fungicides. Specific examples of suitable systemic fungicides are triforine, aluminiumfosetyl, bitertanole, fenarimole, tridemorph, nuarimol, penconazole, or propiconazole.

Preferred systemic nematicides include carbamates, organophosphates, and antibiotic nematicides.

Systemic plant growth regulators include growth promoters, such as auxins, cytokinins, defoliants, ethylene inhibitors, gibberellins; growth inhibitors, such as antiauxins, gibberellin inhibitors and ethylene releasers; and growth retardants.

The aqueous ready-to-use formulations based on systemic pesticides in accordance with the present invention may comprise one systemic pesticide or a combination of systemic pesticides, or a combination of systemic pesticides and at least one systemic plant growth regulator.

The aqueous ready-to-use formulations based on systemic plant growth regulators may comprise one plant growth regulator or a combination of plant growth regulators, or a combination of plant growth regulators and at least one pesticide.

Any kind of microbial inoculants commonly used in the field are suitable for the realization of the present method.

Examples of suitable microbial inoculants are biofertilizer bacteria, such as Rhizobium spp., Agrobacterium radiobacter and specific strains of Azospirillum and Azotobacter, and fungi, such as mycorrhizal fungi, or biopesticide bacteria, such as specific strains of Bacillus thuringiensis and Bacillus subtilis. Mixtures of microorganisms can be also used.

The person skilled in the art in the art can determine the amount of systemic active substance and microbial inoculant, the volume of formulation and the amount of water, depending upon the particular active substance(s), the type of soil, the type of plant, the size of the plant, its root zone and the environment of the plant.

The aqueous ready-to-use liquid formulation of the method of the invention can further comprise a surfactant. Anionic, cationic, non-ionic and amphoteric surfactants and mixtures thereof are suitable surfactants.

Suitable surfactants are, for example, nonionic emulsifiers and dispersants, such as:
polyalkoxylated, preferably polyethoxylated, saturated and unsaturated aliphatic alcohols having 8 to 24 carbon atoms in the alkyl radical and, for example, 1 to 100, preferably 4 to 40, ethylene oxide units (EO);
polyalkoxylated, preferably polyethoxylated, arylalkylphenols, such as, for example, tristyrylphenol having an average degree of ethoxylation of from 8 to 80, preferably from 16 to 40;
polyalkoxylated, preferably polyethoxylated, alkylphenols having one or more alkyl radicals, such as, for example, nonylphenol or tri-sec-butylphenol, and an average degree of ethoxylation of from 2 to 40, preferably from 4 to 20;
polyalkoxylated, preferably polyethoxylated, hydroxy-fatty acids or glycerides of hydroxy-fatty acids, such as, for example, ethoxylated castor oil, having a average degree of ethoxylation of between 10 and 80;
polyglycerol, sorbitan or sorbitol esters with fatty acids or polyalkoxylated, preferably polyethoxylated, polyglycerol, sorbitan or sorbitol esters;
polyalkoxylated, preferably polyethoxylated, amines;
block copolymers from alkylene oxides, for example from ethylene oxide and propylene oxide, having average molar masses between 200 and 8000 g/mol, preferably from 1000 to 4000 g/mol;
alkylpolyglycosides or polyalkoxylated, preferably polyethoxylated, alkylpolyglycosides.

Preferred nonionic surfactants are polyalkoxylated alcohols having 8 to 24 carbon atoms in the alkyl radical; polyglycerol, sorbitan or sorbitol esters with fatty acids, optionally polyalkoxylated; alkylpolyglycosides or polyalkoxylated alkylpolyglycosides; and block copolymers from alkylene oxides.

Also suitable are anionic surfactants, for example:
polyalkoxylated, preferably polyethoxylated, surfactants which are ionically modified, for example by conversion of the terminal free hydroxyl function into a sulfate or phosphate ester;
alkali metal and alkaline earth metal salts of alkylarylsulfonic acids having a straight-chain or branched alkyl chain;
alkali metal and alkaline earth metal salts of paraffin-sulfonic acids and chlorinated paraffin-sulfonic acids;
polyelectrolytes, such as lignosulfonates, condensates of naphthalenesulfonate and formaldehyde and polystyrenesulfonate;
anionic esters of alkylpolyglycosides, such as alkylpolyglucosidesulfosuccinate or citrate;
salts of sulfosuccinates which are esterified once or twice with linear, or branched aliphatic, cycloaliphatic and/or aromatic alcohols or which are esterified once or twice with polyalkoxylated alcohols.

Preferred anionic surfactants are, for example, salts of sulfosuccinates, such as sodium dioctyl sulfosuccinate, and anionic esters of alkylpolyglycosides, in particular alkylpolyglucoside citrate.

Examples of cationic and amphoteric surfactants are quaternary ammonium salts, alkyl amino acids, and betaine or imidazoline amphotensides.

Anionic and non-ionic surfactants are preferred.

Conveniently, the ready-to-use liquid formulation of the invention may also contain adjuvants, pH adjusters, anti-foam agents, corrosion inhibitors, plant nutrients including fertilizers and microelements/micronutrients, and the like. Plant nutrients are preferred.

Examples of suitable fertilizers include sources of nitrogen, of phosphorous, of potassium and mixture thereof. Non-limiting examples of sources of available nitrogen include urea, ammonium nitrate, potassium nitrate, and mixtures thereof. Examples of available phosphorous sources include ammonium phosphate, diammonium hydrogen phosphate, ammonium dihydrogen phosphate, sodium phosphate, disodium hydrogen phosphate, sodium dihydrogen phosphate, and mixtures thereof. Sources of potassium include any suitable water soluble potassium salt.

Non-limiting examples of microelements/micronutrients include chelated iron (chelated with EDTA), chelated manganese, and chelated zinc, and naturally occurring or synthetic compounds containing one or more of calcium, magnesium, iron, copper, zinc, boron and manganese.

The ready-to-use aqueous liquid formulation of the invention can be prepared by simply mixing the depolymerized CMC, the systemic active substance or the microbial inoculants and the other optional ingredients with water.

Typically, the depolymerized CMC is mixed with any ingredient of the ready-to-use formulation as a concentrate liquid solution or dispersion (10-45% by weight). In one embodiment of the method of the invention, the depolymerized CMC is mixed with the ingredients of the liquid aqueous ready-to-use formulation in the form of an aqueous concentrate composition comprising the depolymerized CMC, a compatibilizer and at least one surfactant.

Preferably, said aqueous concentrate composition comprises:
a) from 4 to 25 wt %, preferably from 7 to 20 wt %, of depolymerized CMC;
b) from 10 to 45 wt %, preferably from 15 to 40 wt %, of a compatibilizer chosen in the group consisting of alcohols, esters, glycols, glycol ethers, glycol esters and polyols.
c) from 0.2 to 10 wt %, preferably from 0.5 to 6 wt %, of at least one surfactant.

Alcohols that may be used as compatibilizers in the formulations of the present invention include methanol, ethanol, n-propanol, isopropanol, n-butanol, isobutanol, amyl alcohol, methyl amyl alcohol, cyclohexanol, 2-ethylhexanol, furfuryl alcohol, tetrahydrofurfuryl alcohol and d-limonene. Esters that may be used include ethyl lactate. Glycols and glycol esters that may be used in the formulations of the present invention include monoethylene glycol, diethylene glycol, triethylene glycol, monopropylene glycol, dipropylene glycol, tripropylene glycol, or the methyl, ethyl, n-propyl, n-butyl or t-butyl ethers thereof; 1,3-butanediol, 1,4-butanediol, 2-methyl-1,3-propanediol, 2,2-dimethyl-1,3-propanediol, 2-methyl-1,3-pentanediol, 2-methyl-2,4-pentanediol and 2-methyl-1,3-propanediol. Polyols include glycerol, diglycerol, trimethylol propane, ditrimethylol propane, triethanol propane, pentaerithritol, dipentaerithritol and the like. Blends of various solvents may also be used.

Polyols are the preferred compatibilizers, glycerol being the most preferred polyol.

Suitable surfactants are those mentioned above.

Methods of application of aqueous formulations of systemic active substances are known in the art.

Preferred soil application methods include spreading, for example by spraying, dripping or drenching, furrow application, plant base application, and soil injection or planting hole application.

The ready-to-use liquid formulations of the invention can be also applied to the soil around the base of a plant. The formulation is preferably poured or dripped onto the soil immediately adjacent to the plant's trunk or stem, or to the nearby soil where the roots occur.

The ready-to-use formulations may also be applied by a soil injection method. Soil injections may be made using specialized commercially available injectors to inject the formulation into the soil. Injection holes may be evenly spaced around the base of the trunk or stem, or spaced in a pattern, such as grid or concentric circle pattern. The application onto soil in planting of plants is also possible.

The method of the present invention may be used for the delivery of systemic active substances and microbial inoculants to any type of plant, including trees, shrubs, flowering plants, foliage plants, house plants, groundcover and grass.

### EXAMPLES

Characterization Methods

The Brookfield (BRK) viscosity of the depolymerized CMC solutions was measured with a DV-E Brookfield® viscometer at 20° C. and at 20 rpm.

The dry matter content of the depolymerized CMC solutions was determined in oven set at a temperature of 105° C. for 16 hours

Gel permeation chromatography (GPC) was used to determine the weight average molecular weight (Mw), by using the following method.

Depolymerized CMC samples were prepared by dissolving 0.3 0.3 g of sample in 100 ml of 0.10 M ammonium acetate (mobile phase).

Pullulanes with molecular weights ranging from 5900 to 788000 Da were used as molecular weight standards.

Two hundred microliters of each solution, filtered on a 0.45 micron membrane filter were injected into a HPLC equipped with an evaporative light scattering detector.

The following columns were used at a temperature of 60° C.: Progel-TSK PWXL precolumn, SupelcoProgel—TSK G3000 PWXL, G5000 PWXL and G6000 PWXL. The HPLC was set at a flow rate of 0.8 ml/min for a total run time of 50 minutes.

The active matter content of the depolymerized carboxymethyl cellulose solutions was determined following the same GPC method using a purified CMC (purity>99.5 wt % on dry weight) as standard.

Depolymerized CMC

An aqueous solution of a depolymerized potassium carboxymethyl cellulose (D-CMC) having the characteristics reported in Table 1 was prepared.

TABLE 1

| Characteristics | D-CMC |
|---|---|
| Active Matter (wt %) | 24.8 |
| Dry matter (wt %) | 36.4 |
| BRK Viscosity (mPa*s) | 3,400 |
| M_{w} (Da) | 38,000 |

The depolymerized CMC solution was used to prepare an aqueous concentrate composition (MIX 1) according to the recipe in g of Table 2.

TABLE 2

| Ingredients | MIX 1 |
|---|---|
| D-CMC | 30 |
| Glycerol | 22 |
| Surfactant * | 2.0 |
| Water | up to 100 |

* Coco-polyglucoside citrate, sodium salt

Field Test

The effect of the depolymerized CMC combined with a pesticide or inoculant was evaluated on crops planted in soil artificially or naturally inoculated with pests specifically selected for each crop.

The crops, divided in small plots, were then subjected to irrigation in furrow and/or drip irrigation wherein mixtures of a pesticide/inoculant and D-CMC or MIX 1 were injected in line.

As comparative test, other plots were subjected to drip irrigation with simple water or with the injection of pesticide or inoculant only.

Different parameters were evaluated, in particular stand count, plant vigor and crop yield.

### Example 1—Effect on Control of Fusarium Wilt of Tomato

The test conditions are summarized here below:
Soil Type: Fine sandy loam
Crop: Fresh market tomato
Trial type: Randomized complete block
Fungal Inoculum: Artificial inoculum of Fusarium oxysporum f.sp. lycopersici
Irrigation: Drip
Treatments: Control
   Quadris® (azoxystrobin; Syngenta)
   Quadris+D-CMC
Application Rate: Quadris: 0.66 It/ha
   D-CMC: 1.38 It/ha
Appl. Frequency: 3 wk (fungicide application schedule)
No of Applications: 4

Incidence of disease expressed as stand count over time after planting is shown in

Table 3.

TABLE 3

Stand Count

| Days after planting | 17 | 23 | 30 | 37 |
|---|---|---|---|---|
| Control | 21.8 | 15.8 | 11.8 | 8.3 |
| Quadris | 22.0 | 21.0 | 19.0 | 15.8 |
| Quadris + D-CMC | 21.5 | 20.0 | 19.5 | 19.3 |

Table 4 reports the plant vigor rating at 37 days after planting.

TABLE 4

| Treatment | Plant Vigor* |
|---|---|
| Control | 2.0 |
| Quadris | 3.8 |
| Quadris + D-CMC | 4.8 |

*1 = poor growth, 5 = vigorous growth

The crop yield expressed as total number of fruit per hectare, total fruit weight per hectare and as average individual fruit weight in kg is shown in Table 5.

TABLE 5

| | | Total fruit | Indiv. |
|---|---|---|---|
| | Total fruit | weight/ha | fruit weight |
| Treatment | count/ha | (×100 kg) | (kg) |
| Control | 33760 | 92.6 | 0.27 |
| Quadris | 74244 | 283.2 | 0.38 |
| Quadris + D-CMC | 105763 | 420.2 | 0.40 |

### Example 2—Effect on Control of Root Knot Nematode on Cucumber

The test conditions are summarized here below:
Soil type: Fine sandy loam
Crop: Cucumber
Trial type: Randomized complete block
Fungal inoculum: Natural inoculum of Meloidogyne spp.
Irrigation: Drip
Treatments: Control,
   Nimitz® (Fluensulfone; Adama)
   Nimitz+D-CMC
Application rate: Nimitz: 8.19 It/ha
   D-CMC: 1.42 It/ha
Appl. Frequency: At time of planting
No of Applications: 1

The plant vigor rating and the gall rating on plant roots (disease incidence) at 37 days after planting are shown in Table 6.

TABLE 6

| Treatment | Plant Vigor* | Gall Rating** |
|---|---|---|
| Control | 1.7 | 7.1 |
| Nimitz | 3.2 | 1.47 |
| Nimitz + D-CMC | 3.7 | 1.23 |

*1 = poor growth, 5 = vigorous growth
**1 = None, 10 = severe

Table 7 reports the increase of crop yield expressed as total number of fruit per hectare, total fruit weight per hectare and as average individual fruit weight in kg.

TABLE 7

| | | Total fruit | Indiv. |
|---|---|---|---|
| | Total fruit | weight/ha | fruit weight |
| Treatment | count/ha | (×100 kg) | (kg) |
| Control | 9760 | 43.2 | 0.44 |
| Nimitz | 42523 | 198.7 | 0.47 |
| Nimitz + D-CMC | 48301 | 239.0 | 0.50 |

### Example 3—Effect on Inoculant Performance on Peanuts

The test conditions are summarized here below:
Soil type: Fine sandy loam
Crop: Peanut
Trial type: Randomized complete block
Treatments: Control
   Catapult® (Inoculant; CNI)
   Catapult+MIX 1 (tank mix in furrow)
   Catapult-+MIX 1 (drip irrigation)
   Catapult+MIX 1 (tank mix in furrow+drip irrigation)
Irrigation: Various
Application rate: Catapult: 1.1 It/ha
   MIX 1: 2.34 It/ha (tank mix at planting),
      4.68 It/ha (drip irrigation)
Application: At planting (tank mix),
   30 day cycle from pre-pegging (drip irrigation)
No of Application: 3 (1 at planting+2 drip irrigation)

Tables 8 reports the plant vigor rating at 37 days after planting.

TABLE 8

| Treatment | Irrigation | Plant Vigor* |
|---|---|---|
| Control | | 3.7 |
| Inoculant | In furrow | 4.1 |
| Inoculant + Example 2 | In furrow | 4.6 |
| Inoculant + Example 2 | Drip | 4.4 |
| Inoculant + Example 2 | In furrow + drip | 4.9 |

*1 = poor growth, 5 = vigorous growth

The tests clearly demonstrate that the addition of a depolymerized CMC to a ready-to-use formulation of a systemic active substance or inoculants increases the efficacy of said actives.

1. A method for improving the performance of systemic active substances and microbial inoculants comprising the steps of:
i) preparing a liquid aqueous ready-to-use formulation comprising an effective amount of a systemic active substance or a microbial inoculant and a depolymerized carboxymethyl cellulose (depolymerized CMC) having a weight average molecular weight comprised between 10,000 and 80,000 dalton (Da), and
ii) applying an amount of the aqueous ready-to-use formulation onto soil around the plant such as to have an application rate of said depolymerized CMC of from 0.01 to 3.0 kg/ha.

2. The method of claim 1, wherein the application rate of said depolymerized CMC is from 0.05 to 1.5 kg/ha.

3. The method of claim 1, wherein said depolymerized CMC has a weight average molecular weight comprised between 15,000 and 55,000 Da.

4. The method of claim 1, wherein said depolymerized CMC is salified with potassium ions.

5. The method of claim 1) wherein said depolymerized CMC is prepared using a technical carboxymethyl cellulose having an active substance content of from 55 to 75 wt %, as dry matter.

6. The method of claim 1, wherein said depolymerized CMC is mixed with the ingredients of the liquid aqueous ready-to-use formulation in the form of an aqueous concentrate composition comprising:
a) from 4 to 25 wt % of depolymerized CMC;
b) from 10 to 45 wt % of a compatibilizer, chosen in the group consisting of alcohols, esters, glycols, glycol ethers, glycol esters and polyols;
c) from 0.2 to 10 wt % of at least one surfactant.

7. The method of claim 6, wherein said aqueous concentrate composition comprises:
a) from 7 to 20 wt % of depolymerized CMC;
b) from 15 to 40 wt % of said compatibilizer;
c) from 0.5 to 6 wt % of at least one surfactant.

8. The method of claim 6, wherein said compatibilizer is a polyol.

9. The method of claim 6, wherein said at least one surfactant is chosen among non-ionic and anionic surfactants.
